(19) United States
(12) Patent Application Publication
(10) Pub. No.: US 2022/0164814 A1
(43) Pub. Date: May 26, 2022

(54) AUTOMATICALLY GENERATING INSTANT PRICING STRUCTURE DATA OBJECTS

(71) Applicant: Capital One Services, LLC, McLean, VA (US)

(72) Inventors: Saman BAGHESTANI, Plano, TX (US); Veerendra JOTE, Frisco, TX (US); Brandon DRUMHELLER, Plano, TX (US); Andrew BALDWIN, Dallas, TX (US)

(73) Assignee: Capital One Services, LLC, McLean, VA (US)

(21) Appl. No.: 17/104,888

(22) Filed: Nov. 25, 2020

(51) Int. Cl. G06Q 30/02; G06Q 10/08; G06Q 40/02; G06Q 10/10; G06F 16/22; G06F 16/2457

(52) U.S. Cl. CPC G06Q 30/0206; G06Q 10/087; G06Q 30/0278; G06F 16/24578; G06Q 10/10; G06F 16/2228; G06Q 40/025

(57) ABSTRACT

Provided herein are system, apparatus, device, method and/or computer program product embodiments, and/or combinations and sub-combinations thereof, for generating instant pricing structures. In a given embodiment, a server receives a request to generate sets of instant pricing structure data objects for a vehicle. The server identifies a set of attributes associated with the dealer. For each attribute of the set of attributes, the server identifies a parameter corresponding to a given attribute of the set of attributes and determines a threshold for the parameter. Furthermore, the server generates a set of instant pricing structure data objects of the requested set of instant pricing structure data objects by adjusting a value for the parameter by an incremental amount within the threshold while maintaining each instant pricing structure data object of the set within constraints of a user-provided input and the policy of the lender.

### BACKGROUND

When a customer attempts to purchase a vehicle from a car dealership, the car dealership, in coordination with a lender, can generate a pricing option for the customer. The pricing option may include loan information (that meets lender requirements) and vehicle price information for the vehicle. The customer may want to change elements of the pricing option, such as loan term, vehicle price (e.g., through negotiation), interest rates, or the like, so that the customer can meet their personal payment preference. However, often the customer and the dealer are inaccurately guessing which elements of the pricing option can be adjusted (and the net effects of the adjustments) while remaining within the constraints of the customer's preferences and continuing to meet lender requirements. Furthermore, the pricing option may not be specifically tailored to the customer.

Once a customer has expressed interest in a vehicle, it is beneficial for the car dealership to structure the pricing option to close the sale. A final pricing option offered by the car dealership may be different than the pricing option initially presented to the customer based on adjustments made during negotiations, which may result in the final pricing structure not meeting the customer's preferences, even if the pricing option initially presented to the customer did meet the customer's preferences. Therefore, approaches are needed to ensure that customers may be offered a pricing option that can be adjusted as needed, while remaining within the constraints of the customer's preferences, as well as a lender's requirements, and which reduces wasting of time and operational resources.

### BRIEF DESCRIPTION OF THE FIGURES

The accompanying drawings, which are incorporated herein and form part of the specification, illustrate the present disclosure and, together with the description, further serve to explain the principles of the disclosure and enable a person skilled in the relevant art to make and use the disclosure.

FIG. 1 illustrates an example environment in which systems and/or methods for generating financing structures are implemented according to some embodiments.

FIG. 2 is a block diagram illustrating example functionality of user interfaces displayed on a seller device, according to some embodiments.

FIG. 3 is a flowchart illustrating a process for generating sets of instant pricing data objects, according to some embodiments.

FIG. 4 is a flowchart illustrating a process for identifying a set of instant pricing structure data objects, according to some embodiments.

FIG. 5 is a block diagram of example components of a device, according to some embodiments.

The drawing in which an element first appears is typically indicated by the leftmost digit or digits in the corresponding reference number. In the drawings, like reference numbers may indicate identical or functionally similar elements.

### DETAILED DESCRIPTION

Provided herein are system, apparatus, device, method and/or computer program product embodiments, and/or combinations and sub-combinations thereof, for generating instant pricing structures.

When a potential customer (e.g., a user) walks into a dealership (e.g., a car dealership), a dealer representing the dealership wants to be in the best possible position to close a sale. In the case of a car dealership, this not only means showcasing available vehicles to the customer and getting them to agree to purchase a particular vehicle but also working with the customer to agree on financial terms for the purchase that meet the customer's goals.

In accordance with an embodiment, a server receives a request to generate a plurality of sets of instant pricing structure data objects for a vehicle in an inventory of a dealer. Instant pricing structure data objects may be loan pricing structures. The server identifies a set of attributes associated with the dealer. These attributes may be categories that correspond to attributes of previously selected final instant pricing structure data objects for the dealer. Each attribute may serve as a requirement or additional constraint for the instant pricing structure data object. For example, the attributes may include less front end, more cash down, less backend, no back end, or the like.

For each attribute of the set of attributes, the server identifies a parameter corresponding to a given attribute of the set of attributes and determines a threshold for the parameter. Furthermore, for each attribute of the set of attributes, the server generates a set of instant pricing structure data objects of the requested plurality of sets of instant pricing structure data objects by adjusting a value for the parameter by an incremental amount within the threshold while maintaining each instant pricing structure data object of the set within constraints of a user-provided input and the policy of the lender.

The parameter for each attribute may be part of a set of parameters used to generate an instant pricing structure data object. As such, the server identifies parameters for a given attribute that will allow the instant pricing structure data object which meet the requirements of the given attribute while remaining within the constraints of the input associated with a user and a policy of a lender. For example, in the event the attribute is less front end, the server may identify parameters such as front end value and longer loan term. Each instant pricing structure data object of the plurality of sets of instant pricing structure data objects is unique and constrained based on an input associated with a user and a policy of a lender.

The server transforms an instant pricing structure data object from a set of instant pricing structure data objects of the plurality of sets of instant pricing structure data objects into a final pricing structure data object, in response to a selection of the instant pricing structure data object and independent of further input associated with the user. The server executes an action on the final pricing structure.

The above configuration allows for automatically generating multiple options of instant pricing structures while still staying within the constraints of the input associated with the user and lender policy and remaining consistent with the dealer's preferences. Each of the instant pricing structures can be actionable as they are pre-generated based on a lender's underwriting and pricing algorithms. That is, an instant pricing structure data object, once selected, can share the same data (e.g., projected payments and APR information) as the final pricing structure data object that is accepted by the lender. This ensures that the instant pricing structure data objects do not change once the final pricing structure data object is generated. This way, each instant pricing structure data object is a realistic pricing option for the vehicle. As such, rather than a dealer manually generating a pricing structure and making multiple requests to a lender (as is conventionally done) for pre-approval, this configuration generates multiple potential final pricing structure data objects based on a lender's underwriting and pricing algorithms with a single request. By doing so, this configuration saves operational resources.

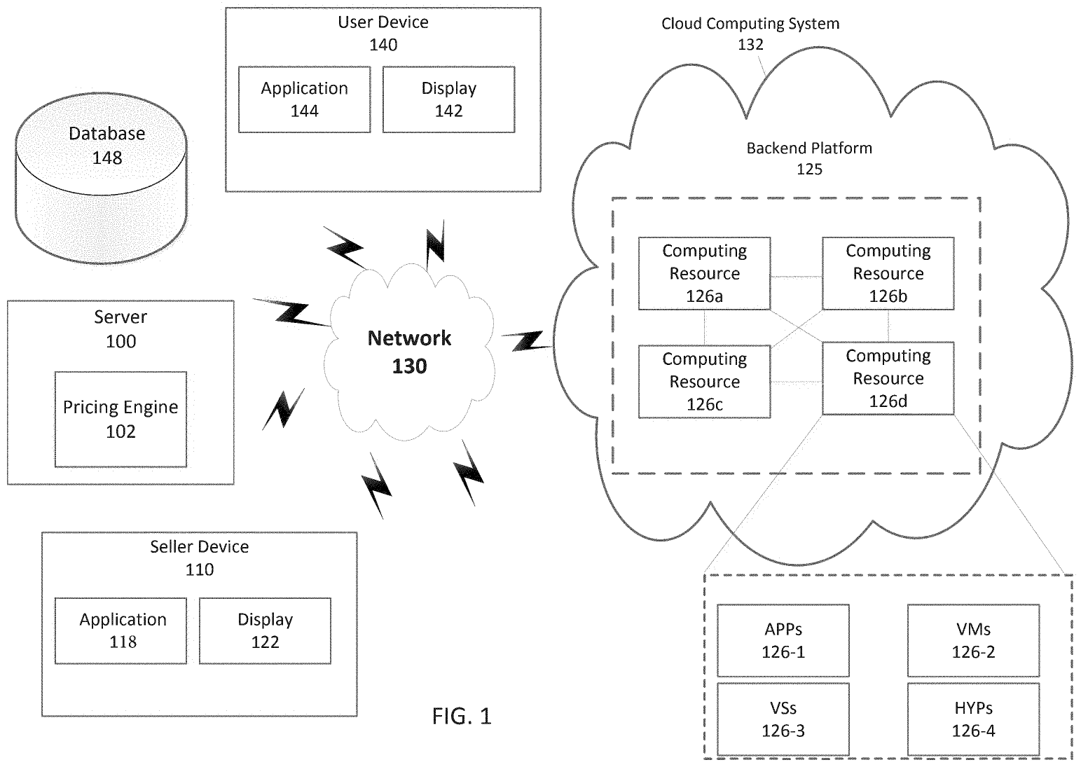

FIG. 1 illustrates an example environment in which systems and/or methods for generating financing structures are implemented according to some embodiments. The environment may include server 100. Server 100 may include a pricing engine 102. The pricing engine 102 can be configured to generate instant pricing structure data objects. The environment may further include a seller device 110, user device 140, and database 148.

Seller device 110 can include application 118 and display 122. User device 140 can include application 144 and display 142. Seller device 110 and user device 140 can use applications 118 and 144 to interface with the server 100, respectively. Applications 118 or 144 can be configured to request and receive instant pricing structure data objects.

Database 148 can be one or more data storage devices configured to store data associated with a dealer, inventory, instant pricing structure data objects, or final pricing structure data objects. Such data objects may describe financial arrangements for the financing of the purchase of a vehicle such as: price, rebate value, cash down, taxes, licensing/plating fees, trade-in values, estimated monthly payment, APR or interest rate, term lengths, amount of back-end product (GAP, Warranty), and a variety of other variables.

The devices of the environment may be connected through wired connections, wireless connections, or a combination of wired and wireless connections. In an example embodiment, one or more portions of the network 130 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

Backend platform 125 may include a server or a group of servers. In an embodiment, backend platform 125 may be hosted in a cloud computing system 132. It may be appreciated that the backend platform 125 may not be cloud-based, or may be partially cloud-based.

The cloud computing system 132 includes an environment that delivers computing as a service, whereby shared resources, services, etc. may be provided to server 100. The cloud computing system 132 may provide computation, software, data access, storage, and/or other services that do not require end-user knowledge of a physical location and configuration of a system and/or a device that delivers the services. The cloud computing system 132 may include computing resources 126a-d. Server 100 may reside inside the cloud computing system 132. Alternatively, server 100 may reside partially outside the cloud computing system 132 or entirely outside the cloud computing system 132.

Each computing resource 126a-d includes one or more personal computers, workstations, server devices, or other types of computation and/or communication devices. The computing resource(s) 126a-d may host the backend platform 125. The cloud resources may include compute instances executing in the cloud computing resources 126a-d. The cloud computing resources 126a-d may communicate with other cloud computing resources 126a-d via wired connections, wireless connections, or a combination of wired and wireless connections.

Computing resources 126a-d may include a group of cloud resources, such as one or more applications (“APPs”) 126-1, one or more virtual machines (“VMs”) 126-2, virtualized storage (“VS”) 126-3, and one or more hypervisors (“HYPs”) 126-4.

Application 126-1 may include one or more software applications that may be provided to or accessed by server 100, seller device 110, and user device 140. For example, applications 126-1 can include pricing engine 102, application 118, and application 144. In an embodiment, server 100 may reside outside the cloud computing system 132 and may execute applications like pricing engine 102 locally. Alternatively, the application 126-1 may eliminate a need to install and execute software applications on server 100, seller device 110, and user device 140. The application 126-1 may include software associated with backend platform 125 and/or any other software configured to be provided across the cloud computing system 132. The application 126-1 may send/receive information from one or more other applications 126-1, via the virtual machine 126-2.

Virtual machine 126-2 may include a software implementation of a machine (e.g., a computer) that executes programs like a physical machine. Virtual machine 126-2 may be either a system virtual machine or a process virtual machine, depending upon the use and degree of correspondence to any real machine by virtual machine 126-2. A system virtual machine may provide a complete system platform that supports the execution of a complete operating system (OS). A process virtual machine may execute a single program and may support a single process. The virtual machine 126-2 may execute on behalf of a user and/or on behalf of one or more other backend platforms 125 and may manage infrastructure of cloud computing system 132, such as data management, synchronization, or long-duration data transfers.

Virtualized storage 126-3 may include one or more storage systems and/or one or more devices that use virtualization techniques within the storage systems or devices of computing resource 126. With respect to a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how administrators manage storage for end users. File virtualization may eliminate dependencies between data accessed at a file level and location where files are physically stored. This may enable optimization of storage use, server consolidation, and/or performance of non-disruptive file migrations.

Hypervisor 126-4 may provide hardware virtualization techniques that allow multiple operations systems (e.g., “guest operating systems”) to execute concurrently on a host computer, such as computing resource 126. Hypervisor 126-4 may present a virtual operating platform to the guest operating systems and may manage the execution of the guest operating systems multiple instances of a variety of operating systems and may share virtualized hardware resources.

In an embodiment, a user may interface with a vehicle dealership in-person or virtually using user device 140. A user may be interested in purchasing a given vehicle from an inventory of the vehicle dealership. Financing options for purchasing the vehicle may be provided to the user. The user may desire to generate a pricing option to project the cost of the vehicle. For example, the user may desire to project the monthly payments based on the price of the vehicle and a loan amount. Furthermore, a user may desire to view different pricing options available to the user while staying within constraints of an input associated with the user. The input may be a maximum desired monthly payment, maximum interest rate, loan term, vehicle price, or the like.

The pricing options may be conveyed in an instant pricing structure object. The instant pricing structure data object may be a unitary data object. Each instant pricing structure data object may store or contain data associated with a pricing option for a vehicle. The data can include a price of the vehicle, loan amount, APR, projected monthly payments, loan term, or the like. Each instant pricing structure data object may be stored in a single database record in database 148. This way, an instant pricing structure data object can be easily retrieved from database 148.

An instant pricing structure object may be generated using various parameters. These parameters can include term, sales price, cash down, trade value, warranty, gap, participation, rebate, alternative vehicles. Each of the parameters may correspond with values that may affect the instant pricing structure data object.

A user may provide user information for generating instant pricing structure data objects for the given vehicle using application 144. Alternatively, the user can also provide information for generating instant pricing structure data objects to a seller or dealer. The seller or dealer can input the user's information using application 118. The information may include the user's full name, social security number, address, employment information, or other personal information, such as would be needed for credit verification or vehicle purchase. The user may also provide the input for constraining the instant pricing structure data objects. The input can be a maximum monthly payment, interest rate, vehicle price, loan term, or the like. The input can be provided through a user interface of application 144 or application 118. The user interface can include a text input box, dropdown menu, links, or the like, for providing the input.

In the event the user is virtually interfacing with the vehicle dealer, application 144 can transmit the user information, input, and information about the given vehicle to server 100. Server 100 can forward the user information, input, and information about the given vehicle to application 118. Alternatively, in the event the user is interfacing with the vehicle dealer in-person, application 118 can receive the user information and input from the dealer operating seller device 110. A dealer can also hand the user the seller device 110 so that the user can input the user information and input using application 118.

In a given embodiment, a user may use application 144 to identify preferred vehicles that may be within the inventory of the dealer. The preferred vehicles may be transmitted to server 100. Server 100 may store the preferred vehicles in database 148 or some other storage device. Application 118 transmits a request to server 100 to retrieve information about a user's preferred vehicles (if any), using the user information.

The user information, input, and information about the given vehicle can be verified for errors. For example, if the user provides the user information and input through application 144 or directly on application 118, the dealer can review the user information and input on application 118 for any errors or missing information. Application 118 can transmit a request to generate sets of instant pricing structure data objects for the user and the given vehicle to server 100. The sets of instant pricing structure data objects can be two or more sets. In some embodiments, application 118 can transmit a request to generate a single set or a single instant pricing structure data object. The request can include the user information, input, information about the given vehicle. Information about the given vehicle can include make, model, year, VIN, vehicle price, or the like. In some embodiments, the request can also include a dealer identifier.

Server 100 can receive the request to generate the sets of instant pricing structure data objects for a given vehicle in the inventory of the vehicle dealer. Pricing engine 102 may identify the dealer using the dealer identifier. Alternatively, pricing engine 102 can identify the dealer based on where the vehicle is currently listed in stock using the information about the given vehicle (e.g., VIN). Furthermore, pricing engine 102 can identify the dealer by identifying seller device 110 that transmitted the request. The seller device 110 can correspond with a dealer.

Pricing engine 102 can retrieve previous final pricing structure data objects agreed upon by the dealer. Pricing engine 102 can identify a set of attributes associated with the dealer based on the previous final pricing structure data objects. The attributes may be tendencies or preferences of a dealer when agreeing upon a final pricing structure data object. For example, attributes can include a ratio of the backend value of the sales price and the frontend value of the sales price, percentage of the sales price that is the backend value as compared to the total value of the vehicle, funded structured flag, the percentage of down payment, details related to the vehicle (e.g., condition of the vehicle, whether the vehicle is new or used, type of vehicle, or the like), or the like. The funded structured flag may indicate whether the seller prefers protection for assuming the credit risk. The frontend value of a price of a vehicle may include the price of the vehicle itself. The backend value of the price of the vehicle may include warranties and maintenance of the vehicle. In some embodiments, pricing engine 102 can implement an unsupervised machine learning algorithm to determine attributes about the dealer based on the previously agreed upon final pricing structure data objects.

A lender may provide their methodology and policies to database 148. As an example, server 100 and database 148 may be associated with the lender. Pricing engine 102 can retrieve a lender's policy and methodology for generating an instant pricing structure from database 148. The lender's policy and methodology can include Bayesian regression algorithms, decision trees, pricing grids, or various equations to generate instant pricing structure data objects. As an example, the lender's methodology may include interfacing with a third-party credit bureau to execute a soft pull for the user. Soft pulls are soft credit inquires that do not affect the user's credit score. The user information, soft pull information, input, and information about the given vehicle can be values of parameters used to generate the instant pricing structure data object using the lender's policies and methodologies. Each instant pricing structure can be specifically generated based on the user's unique information and the given vehicle.

Each instant pricing structure data object can be generated using the lender's methodology (e.g., based on proprietary pricing algorithms) and within the constraints of the lender's underwriting policies. The lender's methodology may involve calculating an APR, a required down payment, loan term, monthly payments, for the user purchasing the given vehicle, using the user information, soft pull information, and information about the given vehicle.

The attributes may serve as constraints or requirements when generating instant pricing structure data objects. For example, an attribute may be “low front end value.” As such, instant pricing structure data objects for this attribute may have a front value below a predetermined amount.

For each attribute of the set of attributes, pricing engine 102 can identify one or more parameters associated with a given attribute. The one or more parameters may be part of a set of parameters used to generate instant pricing structure data objects. Pricing engine 102 may determine that values for the one or more parameters of the set may be incrementally adjusted for generating each instant pricing structure data object for the given attribute, while still maintaining each instant pricing structure data object for the given attribute within the requirement or constraint of the given attribute and the constraints of the input and lender's policy.

Pricing engine 102 may also determine a threshold that one or more parameters may be adjusted. As a non-limiting example, the threshold may be determined based on one or more of a dealer's historical sales data, predetermined information, information associated with the attribute.

For example, in the event the attribute is a “low front end value” and the identified one or more parameters are front end value and loan term, pricing engine 102 may determine a threshold for how much the front end value may be adjusted and how much the loan term may be adjusted. Pricing engine 102 may determine that because the attribute is a “low front end value,” the front end value may not be higher than a predetermined amount or percentage of the final sales price. Furthermore, pricing engine 102 may also determine, based on the dealer's historical sales data, that the dealer does not finalize sales for which a front end value is lower than a given amount. As such, the threshold for the front end value may include a maximum and minimum amount. Similarly, pricing engine 102 may determine a minimum and maximum threshold, based for the loan term on one or more of: a dealer's historical sales data, predetermined information, information associated with the attribute.

The predetermined information may be information based on common practices in the vehicle sale and loan business. For example, predetermined information about a loan term may include common loan terms for vehicle loans. In this regard, the predetermined information for loan term may indicate that loan terms more than 84 months do not exist.

Once the thresholds for the one or more parameters associated with the given attribute have been determined, pricing engine 102 may generate a set of instant pricing structure data object for the given attribute. Pricing engine 102 may incrementally vary the one or more parameters for the given attribute within the identified thresholds of the one or more parameters when generating each instant pricing structure. Each instant pricing structure data object may be within the constraints or requirements of the attribute, the input, and the lender's policy. Similarly, pricing engine 102 may generate a set of instant pricing structure data objects for each attribute of the set of attributes associated with the dealer by incrementally varying the values for one or more parameters associated with each respective attribute. Each set of instant pricing structure can correspond with a given attribute in the set of attributes.

Pricing engine 102 generates each instant pricing structure data object to be unique and within constraints of a given attribute, the input associated with the user, and the policy of the lender. Furthermore, each instant pricing structure data object is unique for a specific user and vehicle.

As a non-limiting example, a user or dealer can provide user information, an input, and vehicle information using application 118 or application 144 to generate sets of instant pricing structure data objects for the specific user and vehicle, as described above. The input may be a maximum or target monthly loan payment amount. The request to generate the sets of instant pricing data objects for the user and vehicle may be transmitted to server 100. The request may include the user information, information about the vehicle, the input, an identifier of the dealer, and an identifier of a lender. The request may include instructions the sets of instant pricing structure data objects for the user and vehicle, within the constraints of the input and credit policy of the lender. Other constraints may include credit profile of the customer, a lender's credit policy, customer equity, income, economic profile, asset profile (i.e., vehicle details), or the like.

Pricing engine 102 may receive the request to generate the sets of instant pricing structure data objects. Pricing engine 102 may retrieve the credit policy of a lender from database 148. Furthermore, pricing engine 102 may retrieve information about the dealer using the dealer identifier from database 148. The information may include previously agreed upon final pricing structures, inventory information, sales records, or the like.

Pricing engine 102 may identify a set of attributes for generating the sets of instant pricing structure data objects. The attributes may be categories which correspond with a different set of instant pricing structure data objects of the requested sets of instant pricing structure data objects. For example, attributes can include instant pricing structure data objects with less front end, instant pricing structure data objects with more cash down, instant pricing structure data objects with less back end, instant pricing structure data objects with no back end, or the like. Pricing engine 102 may identify the set of attributes based on information associated with the dealer, as described above. In some embodiments, the dealer may select the set of attributes.

For each attribute of the set of attributes, pricing engine 102 may identify one or more parameters associated with the parameters. As an example, the parameters may be term, sales price, cash down, trade value, warranty, gap, participation, rebate, alternative vehicles, or the like. Each of the parameters may have corresponding values. These values, when adjusted, may affect the values of the instant pricing structure data object. For example, adjustment of the parameters may affect Loan-to-Value (LTV), Payment to Income (PTI) ratio, Front End percentage (FE %), Front End Amount (FE$), Total Amount Financed, etc . . . . As such, pricing engine 102 may identify the one or more parameters identified for a given attribute, on the basis that the varying the one or more parameters would allow the instant pricing structure objects to remain within the constraints or requirements of the attribute, input, credit policy, and any other constraints.

Pricing engine 102 may also identify thresholds for the one or more parameters for each attribute, as described above. The thresholds may be a minimum and maximum value that a parameter may be adjusted. For example, if a parameter is “cash down,” the pricing engine 102 may determine that the value of cash down may not be adjusted more than the vehicle sales price and so the maximum of the value of cash down is less than the vehicle sales prices. Moreover, pricing engine 102 may determine that based on the information about the lender, the lender may require a certain percentage cash down for a given loan. Therefore, the minimum value for the cash down parameter may be the lender's minimum cash down requirement.

For each attribute of the set of attributes, pricing engine 102 may generate a set of instant pricing structures by varying the one or more parameters associated with the respective attribute by an incremental amount within the thresholds of the one or more parameters when generating each instant pricing structure data object. Each instant pricing structure may remain within the constraints of the attribute, input, credit policy, and any other constraints.

Pricing engine 102 may rank the instant pricing structure data objects within each set based on a likelihood of the instant pricing structure data objects being selected. The likelihood of being selected may be a numerical score determined based on a comparison of the values of a given instant pricing structure data object to other instant pricing structure data objects in the set. The higher the numerical score may indicate more of a likelihood of selection. For example, the likelihood of the instant pricing structure data objects based on a similarity of a given instant pricing structure data object to a previously selected final pricing structure for the dealer. Alternatively, or in addition to, the likelihood of the instant pricing structure data object of being selected may be determined based on the proximity of the values of a given instant pricing structure data object to the respective attribute, input, lender credit policy, thresholds of the one or more parameters, or other constraints.

Pricing engine 102 may select one or more of the highest ranked (e.g., top 3, top 5, top 10, etc.) instant pricing structure data objects from each set corresponding to each attribute. Pricing engine 102 may generate an interface, including each of the selected instant pricing structure data objects categorized based on the attributes. Pricing engine 102 may cause the display of the interface on application 114 or application 118.

In some embodiments, each of the instant pricing structure data objects for each set may be displayed on application 114 or application, categorized by attribute. In other embodiments, pricing engine 102 may rank instant pricing structure data objects for each set for the dealer and user. The rankings may be different for the dealer as compared for the user. For example, pricing engine 102 may rank the instant pricing structure data objects for each set for the dealer based on a likelihood of a dealer to agree to the instant pricing structure data objects. Pricing engine 102 may determine this based on elements of previous final pricing structure data objects by the dealer. Pricing engine 102 may use the elements to identify tendencies and preferences of the dealer. Pricing engine 102 may also use the elements to determine tendencies and preferences of previous users and use the tendencies and preferences of other users to rank the instant pricing data structures in each set for the user. The ranked instant pricing data structures for the user may be displayed on application 114. The ranked instant pricing data structures for the dealer may be displayed on application 118.

In some embodiments, the dealer can use application 118 to specify for which attributes the dealer would like to instant pricing structure data objects. For example, dealer can specify that they would like to see instant pricing structure data objects for attributes low cash down and low front end value. Pricing engine 102 may exclude the instant pricing structure data objects generated for attributes other than low cash down and low front end value, when causing display of the instant pricing structure data objects.

In some embodiments, application 118 may display each generated instant pricing structure data objects for each attribute. The dealer may interface with application 118 to select an attribute. Application 118 may remove the instant pricing structure data objects corresponding to the unselected attributes from the interface of application 118 and may only display the instant pricing structure data objects corresponding to the selected attribute.

In some embodiments, pricing engine 102 may also rank the attributes based on a preference indicated by the dealer or determined by pricing engine 102 based on information about the dealer. The interface may include each of the selected instant pricing structure data objects categorized based on the attributes and the attributes may be presented in a ranked order.

In some embodiments, pricing engine 102 may include a set of instant pricing data structure objects corresponding to a single attribute on the interface. Pricing engine 102 may select the single attribute based on a selection from the dealer or based on information about the dealer.

In some embodiments, in response to receiving a request to generate sets of pricing structure data objects for a specific user and vehicle, pricing engine 102 may generate the sets of instant pricing structure data objects by varying values of different parameters within the constraints of the input, lender's credit policy, and other constraints. The sets of instant pricing structure data objects may be permutations of all possible instant pricing structure data objects of the vehicles in the inventory of a given dealer. The sets of instant pricing structure data objects may be grouped based on attributes (e.g., low front end, high back end, no back end, etc.). As such, each group may include a set of instant pricing structure data objects.

Pricing engine 102 may identify a set of attributes associated with the dealer. For each attribute of the set of attributes, pricing engine 102 may identify one or more parameters, as described above. Pricing engine 102 may also identify thresholds for the one or more parameters, as described above. For each attribute of the set of attributes, pricing engine 102 may identify a set of instant pricing structure data objects from the sets of instant pricing structure data objects, for which the values of the one or more parameters associated with the respective attribute have been varied within a threshold of the one or more parameters, while the values of the other parameters remain constant default values. Furthermore, the values of the identified sets of instant pricing structure data objects for each attribute may be within the constraints of the respective attribute, input, lender's credit policy, and other constraints. The identified sets of the instant pricing structure data objects may be for the specific user and vehicle.

In some embodiments, pricing engine 102 may generate additional instant pricing structure data objects than are transmitted to application 118. For example, pricing engine 102 can generate thousands of instant pricing structure data objects per set, and it may be undesirable to present so many instant pricing structure data objects for possible selection.

When the user agrees to an instant pricing structure with the dealer, the dealer may use application 118 to select the agreed-upon instant pricing structure data object. Application 118 may transmit a request to transform the selected instant pricing structure data object into a final pricing structure data object to server 100. The request may include information about the instant pricing structure data object. Pricing engine 102 can use information in the instant pricing structure data object (e.g., APR, vehicle price, loan term, or the like), and transform the instant pricing structure data object into a final pricing structure data object. The final pricing structure data object may include identical data as the instant pricing structure data object. The final pricing structure data object may include additional details about the user and the loan, such as a hard credit inquiry about the user (e.g., a full credit report) and final loan details. The final pricing structure data object may be used to obtain the loan and purchase of a vehicle. Each of the instant pricing structure data objects can be an actionable instant pricing structure.

Server 100 may receive the selection of the instant pricing structure data object. Pricing engine 102 may transform the instant pricing structure data object to a final pricing structure data object. The final pricing data object can share the same information as the instant pricing structure data object. Pricing engine 102 can execute an action on the final pricing structure. The action can be the purchase of a vehicle.

In some embodiments, application 118 may transmit a request to server 100 to adjust an element of an instant pricing structure data object. The pricing engine 102 can determine a threshold amount in which the element can be adjusted so that the instant pricing structure data object remains within the constraints of the input associated with the user and the policy of the lender. Pricing engine 102 can provide options for adjusting the element within the threshold amount, to application 118.

For example, the element can be a price of a vehicle. Pricing engine 102 can determine a threshold amount the price of the vehicle can be adjusted so that the instant pricing structure data object remains within the constraints of the input associated with the user and the policy of the lender. Pricing engine 102 can provide options for adjusting the vehicle price by the threshold amount to application 118.

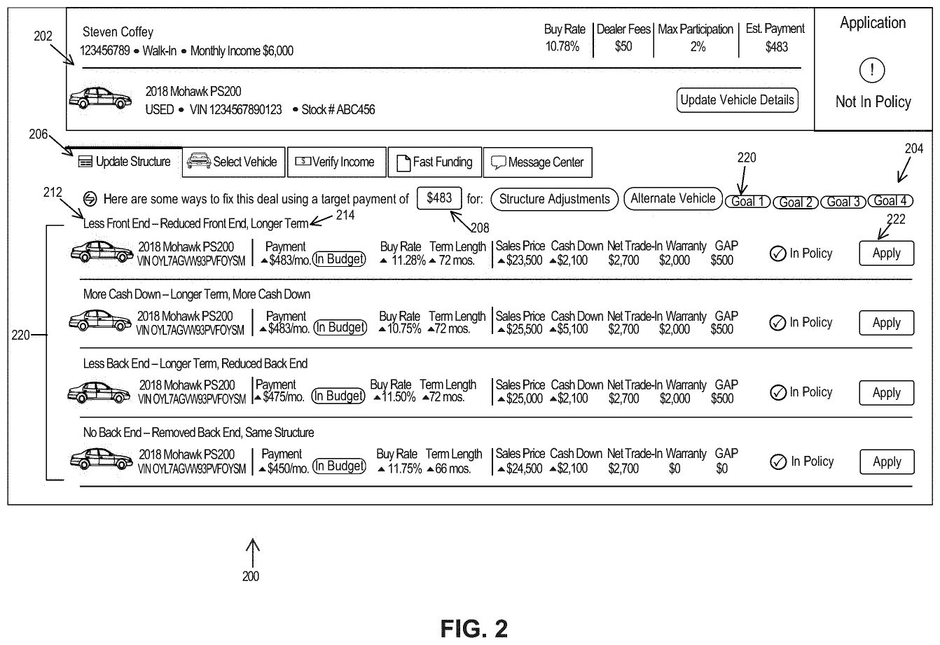

FIG. 2 is a block diagram of a user interface rendered on an application of a seller device or user device, according to some embodiments. FIG. 2 shows examples meant to illustrate the concepts and may not accurately reflect realistic structures. User interface 200 may be rendered on application 118 or application 144. User interface 200 may be used to generate instant pricing structure data objects for a specific vehicle and user. User interface 200 may include user interface elements 202 and 204.

User interface element 202 may include information about the user and the vehicle. The information about the user can include the name of the user, a customer number/identifier, or monthly income. The information about the vehicle may include make, model, year, buy rate (e.g., APR, interest rate, or the like), VIN, stock number, estimated payment, dealer fees, and max participation.

User interface element 204 may include multiple tabs 206. Tabs 206 may include an updated structure tab, select vehicle tab, verify income tab, fast funding tab, and message center tab. In the update structure tab, user interface element 204 may include an input box 208. Input box 208 may be used to input a “goal” or constraint for generating instant pricing structure data objects. For example, input box 208 may be configured to receive a maximum monthly payment amount.

User interface element 204 may also include a list 210 of instant pricing structure data objects categorized based on attribute 212. Parameters 214 associated with each respective attribute may be rendered adjacent to each attribute 212. Each of the instant pricing structure data objects in list 210 may be the highest-ranked instant pricing structure data object within the set of the respective attribute 212.

As a non-limiting example, pricing engine 102 may receive a request to generate sets of instant pricing structure data objects. The request can include the user information, an input associated with the user, and information about the given vehicle. The input associated with the user can be a target monthly payment of $483 for a given vehicle (e.g., 2018 Mohawk PS 200).

Pricing engine 102 may identify attributes 212 associated with the dealer, as described above. Attributes 212 may include less front end, more cash down, less back end, and no back end. Pricing engine 102 may identify one or more parameters 214 for each of attributes 212, for which the values may be varied such that the instant pricing structure is within the constraints of the respective attribute, input (e.g., $483), lender's credit policy, and other constraints, as described above. Parameters 214 for less front end may be reduced front end and longer loan term. Parameters 214 for more cash down may be longer term and more cash down. Parameters 214 for less back end may be longer term and reduced back end. Parameters 214 for no back end may be remove back end and same structure.

Pricing engine 102 may determine thresholds for each of parameters 214, as described above. Pricing engine 102 may generate sets of instant pricing structure data objects for each attribute 212 by incrementing the values of the one or more parameters for each respective attribute within the threshold while maintaining the instant pricing structures within the constraints of the attribute, input, lender's policy, and other constraints. Pricing engine 102 can use a lender's methodology for calculating/generating an instant pricing structure data object. The methodology may use user information and information about the given vehicle to generate the instant pricing structure data object. Furthermore, the methodology can include Bayesian regression algorithms, decision trees, pricing grids, or various equations to generate instant pricing structure data objects

Pricing engine 102 may rank the instant pricing structures within each set based on the likelihood of being selected. Pricing engine 102 may identify the highest-ranked instant pricing structure data object for each attribute 212 and generate interface 200, including the identified instant pricing structure data object for each attribute 212. Pricing engine 102 may cause display of interface 200 by application 118 or application 144.

Information about the instant pricing structure data objects may be included in user interface element 204. The information may include monthly payment amount, buy rate, term length, sales price, cash down, net trade-in, warranty, and GAP. User interface element 204 may also indicate whether the instant pricing structure data object is within budget and in-policy.

User interface element 204 may also include options to change “goals” by selecting one of the goals button 220. Each goal may correspond to a user or dealer goal. For example, different goals may correspond to different inputs. Furthermore, different goals may correspond to desired attributes or constraints. By selecting one of the goals buttons 220, a request to generate sets of instant pricing structure data objects may be transmitted to pricing engine 102. The request may include the details of the selected goal.

An instant pricing structure data object may be selected by selecting apply button 222. Pricing engine 102 may transform the instant pricing structure data object to a final pricing structure data object. The final pricing data object can share the same information as the instant pricing structure data object. Pricing engine 102 can execute an action on the final pricing structure. The action can be the purchase of a vehicle.

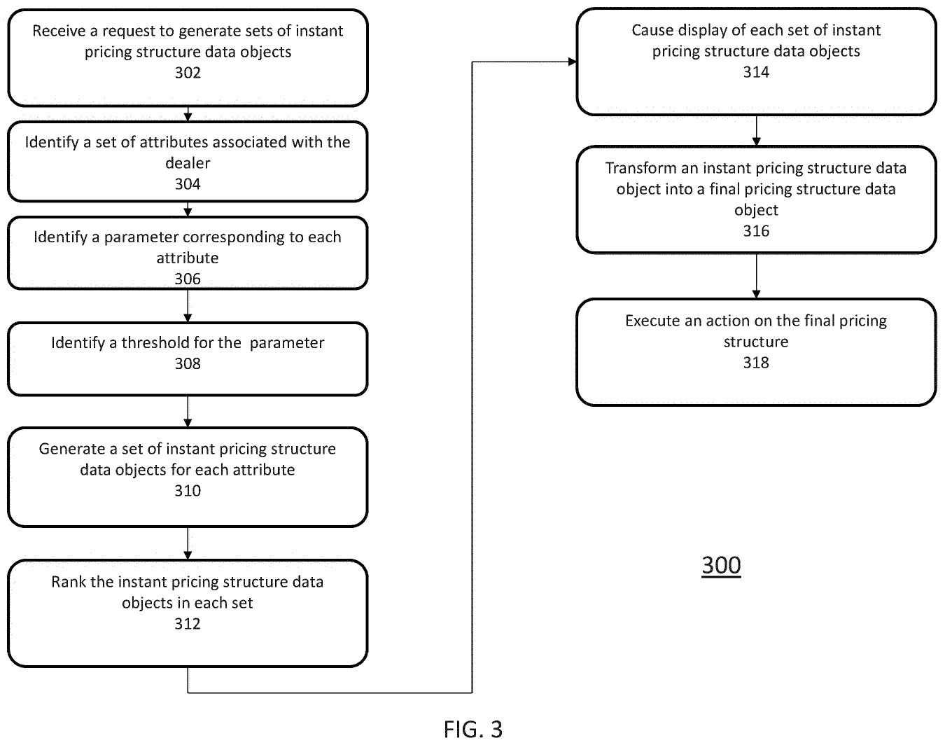

FIG. 3 is a flowchart illustrating a process for generating sets of instant pricing structures, in accordance with an embodiment. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously or in a different order than shown in FIG. 3, as will be understood by a person of ordinary skill in the art.

Method 300 shall be described with reference to FIG. 1. However, method 300 is not limited to that example embodiment.

In operation 302, server 100 receives a request to generate sets of instant pricing structure data objects for a vehicle in an inventory of a dealer. Each instant pricing structure data object is to be unique and constrained based on an input associated with a user, policy of a lender, and other constraints. The instant pricing structure data object may be for a loan for the vehicle. The input can be a desired monthly payment amount, interest rate, loan term, or the like. The dealer can provide input on the seller device.

In operation 304, server 100 identifies a set of attributes associated with the dealer. The attributes may be associated with previously selected final pricing structure data objects. For example, the attributes may include the preferences of a dealer for generating final pricing structure data objects. The attributes can include the final sale price of the vehicle, a ratio of the backend value of the sales price and the frontend value of the sales price, percentage of the sales price that is the backend value as compared to the total value of the vehicle, funded structured flag, the percentage of down payment, details related to the vehicle (e.g., condition of the vehicle, whether the vehicle is new or used, type of vehicle, or the like), or the like.

In operation 306, server 100 identifies a parameter corresponding to each attribute. The parameter may be used to generate an instant pricing structure data object. Server 100 identifies the parameter for a given attribute such that the instant pricing structure data object remains within the constraints of the given attribute, input, lender's policy, and other constraints. For example, parameters can include term, sales price, cash down, trade value, warranty, gap, participation, rebate, alternative vehicles, or the like.

In operation 308, server 100 identifies a threshold for the parameter. The threshold may be a minimum or maximum value for the parameter. Server 100 may determine the threshold based on constraints of the attribute, input, lender policy, or other constraints. Furthermore, server 100 may also determine the threshold based on historical data associated with the dealer, predetermined information about the parameter, or information about the user or vehicle.

In operation 310, server 100 generates a set of instant pricing structure data objects of the requested sets of instant pricing structure data objects for each attribute of the set of attributes by incrementally varying the values of the parameter within the threshold of the parameter, of each respective attribute. Each instant pricing structure data object is within the constraints of the respective attribute, input, lender's policy, and other constraints.

In operation 312, server 100 ranks the instant pricing structure data objects in each set of instant pricing structure data objects based on a score indicating a likelihood of being selected. The likelihood of being selected can be determined based on previously selected instant pricing structure data objects. For example, server 100 can match characteristics of the previously selected instant pricing structure data objects to the instant pricing structure data objects in each of the set of instant pricing structure data objects. Those instant pricing structure data objects that most closely match the previously selected instant pricing structure data objects can be ranked higher within the set of instant pricing structure data objects.

In operation 314, server 100 causes display of the sets of instant pricing structure data objects on seller device 110. The sets of instant pricing structure data objects can be rendered broken up by set. A portion of each set of instant pricing structure data objects of each set of instant pricing structure data rendered. For example, the top-ranked (e.g., top five, ten, or the like) instant pricing structure data objects can be rendered for each set of instant pricing structure data objects.

In operation 316, server 100 transforms an instant pricing structure data object from the sets of instant pricing structure data objects into a final pricing structure data object, in response to a selection of the instant pricing structure data object and independent of further input associated with the user. The instant pricing structure data object can be an actionable instant pricing structure data object. That is, the final pricing structure data can include the same data as the pricing structure data object.

In operation 318, server 100 executes an action on the final pricing structure. The action can be completing a purchase of the vehicle.

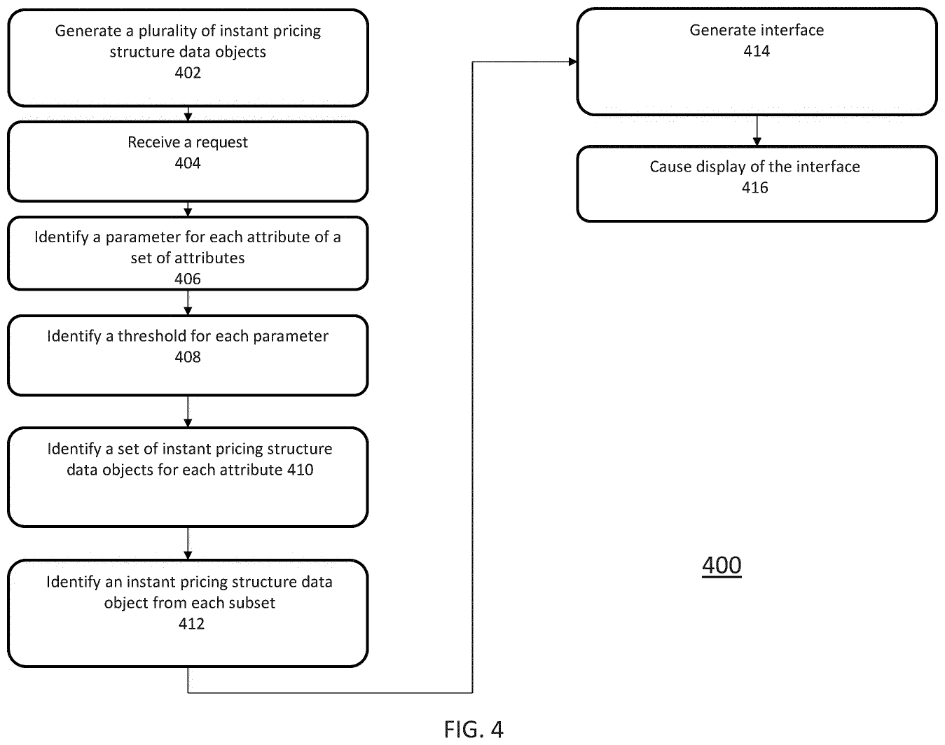

FIG. 4 is a flowchart illustrating the process for identifying a set of instant pricing structures from a plurality of instant pricing structures. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously or in a different order than shown in FIG. 4, as will be understood by a person of ordinary skill in the art.

Method 400 shall be described with reference to FIG. 1. However, method 400 is not limited to that example embodiment.

In operation 402, server 100 generates a plurality of instant pricing structure data objects for each vehicle in the dealer's inventory. The plurality of instant pricing structure data objects may be all the possible permutations of instant pricing structure data objects for each vehicle in the dealer's inventory. Each instant pricing structure data object is to be unique. The instant pricing structure data object may be for a loan for the vehicle. The input can be a desired monthly payment amount, interest rate, loan term, or the like. The dealer can provide input on the seller device.

In operation 404, server 100 receives a request to identify an instant pricing structure data object for each of a set of attributes from the plurality of instant pricing structure data objects for a specific user and vehicle. The request may include an input provided by the user. For example, the input may be a maximum monthly payment amount.

In operation 406, for each attribute of the set of attributes, server 100 identifies a parameter from the set of parameters corresponding to the respective attribute, the value of which can be varied to generate instant pricing structure data objects within the constraints of the attribute, input, lender policy, and other constraints.

In operation 408, server 100 may identify a threshold of each parameter. The threshold may be a minimum or maximum value for the parameter. Server 100 may determine the threshold based on constraints of the attribute, input, lender policy, or other constraints. Furthermore, server 100 may also determine the threshold based on historical data associated with the dealer, predetermined information about the parameter, or information about the user or vehicle.

In operation 410, for each attribute of the set of attributes, server 100 identifies a set of instant pricing structure data objects from the plurality of instant pricing structure data objects for which the parameter corresponding to the respective has been varied within the threshold, while the values of the other parameters remain constant default values. The identified sets may be for the specific user and vehicle, and the identified sets may be within the constraints of the given attribute, input, lender policy, and other constraints.

In operation 412, server 100 identifies an instant pricing structure data object from each set. Server 100 may identify an instant pricing structure data object with the highest likelihood of being selected out of each respective set. Each of the identified instant pricing structure data objects may correspond to an attribute of the set of attributes.

In operation 414, server 100 generates an interface including each identified instant pricing structure data objects categorized based on attribute. The interface may include information about the instant pricing structure data object.

In operation 416, server 100 causes display of the interface on application 118 or application 144. A user or dealer may interact with the interface to select and finalize an instant pricing structure. Alternatively, a user or dealer may modify the constraints to generate new instant pricing structures.

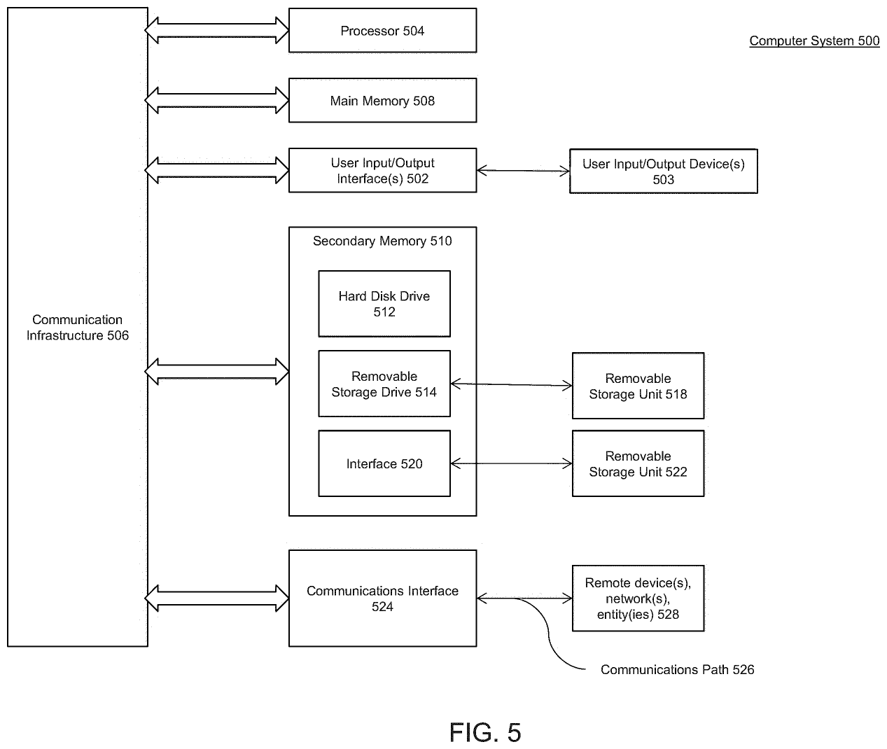

FIG. 5 is a block diagram of example components of device 500. One or more computer systems 500 may be used, for example, to implement any of the embodiments discussed herein, as well as combinations and sub-combinations thereof. Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514.

Removable storage drive 514 may interact with a removable storage unit 518. Removable storage unit 518 may include a computer usable or readable storage device having stored thereon computer software (control logic) and/or data. Removable storage unit 518 may be program cartridge and cartridge interface (such as that found in video game devices), a removable memory chip (such as an EPROM or PROM) and associated socket, a memory stick and USB port, a memory card and associated memory card slot, and/or any other removable storage unit and associated interface. Removable storage drive 514 may read from and/or write to removable storage unit 518.

Secondary memory 510 may include other means, devices, components, instrumentalities, or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the disclosure that others may, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A computer-implemented method comprising:
receiving, by one or more computing devices, a request to generate a plurality of sets of instant pricing structure data objects for a vehicle in an inventory of a dealer, each instant pricing structure data object being unique, and being constrained based on an input associated with a user and a policy of a lender;
identifying, by the one or more computing devices, a set of attributes associated with the dealer;
for each attribute of the set of attributes:
identifying, by the one or more computing devices, a parameter corresponding to a given attribute of the set of attributes;
determining, by the one or more computing devices, a threshold for the parameter;
generating, by the one or more computing devices, a set of instant pricing structure data objects of the requested plurality of sets of instant pricing structure data objects by adjusting a value for the parameter by an incremental amount within the threshold while maintaining each instant pricing structure data object of the set within constraints of the input and the policy of the lender;
transforming, by the one or more computing devices, an instant pricing structure data object from the set of instant pricing structure data objects of the plurality of sets of instant pricing structure data objects into a final pricing structure data object, in response to a selection of the instant pricing structure data object and independent of further input associated with the user; and
executing, by the one or more computing devices, an action on the final pricing structure.

2. The method of claim 1, further comprising ranking, by the one or more computing devices, instant pricing structure data objects within each set of instant pricing structures data objects based on a score indicating a likelihood of being selected.

3. The method of claim 2, wherein the score indicating a likelihood of being selected is based on previously selected instant pricing structure data objects.

4. The method of claim 1, further comprising:
receiving, by the one or more computing devices, a request to adjust an element of the selected instant pricing structure data object; and
providing, by the one or more computing devices, an option for adjusting the element within a predetermined threshold, wherein adjusting the element within the predetermined threshold maintains the instant pricing structure data object within the constraints of the input associated with the user and the policy of the lender.

5. The method of claim 1, wherein the set of attributes are associated with previously selected final pricing structure data objects.

6. The method of claim 1, further comprising causing display, by the one or more computing devices, of each set of instant pricing structures on a user device.

7. The method of claim 1, wherein the threshold for each respective parameter is determined based on historical data associated with the dealer and a predetermined limit associated with the respective parameter.

8. The method of claim 1, wherein the action is completing a purchase of the vehicle using the final pricing structure.

9. A system comprising:
a memory;
a processor coupled to the memory, the processor configured to:
receive a request to generate a plurality of sets of instant pricing structure data objects for a vehicle in an inventory of a dealer, each instant pricing structure data object being unique, and being constrained based on an input associated with a user and a policy of a lender;
identify a set of attributes associated with the input;
for each attribute of the set of attributes:
identify a parameter corresponding to a given attribute of the set of attributes;
identify a threshold for the parameter; and
generate a set of instant pricing structure data objects of the requested plurality of sets of instant pricing structure data objects by adjusting a value for the parameter by an incremental amount within the threshold while maintaining each instant pricing structure data object of the set within constraints of the input and the policy of the lender;
transform an instant pricing structure data object from the set of instant pricing structure data object of the plurality of sets of instant pricing structure data objects into a final pricing structure data object, in response to a selection of the instant pricing structure data object and independent of further input associated with the user; and
execute an action on the final pricing structure.

10. The system of claim 9, the processor further configured to rank instant pricing structure data objects within each set of instant pricing structures data objects based on a score indicating a likelihood of being selected.

11. The system of claim 9, the processor further configured to:
receive a request to adjust an element of the selected instant pricing structure data object; and
provide an option for adjusting the element within a predetermined threshold, wherein adjusting the element within the predetermined threshold maintains the instant pricing structure data object within the constraints of the input associated with the user and the policy of the lender.

12. The system of claim 9, wherein the set of attributes are associated with previously selected final pricing structure data objects.

13. The system of claim 9, the processor further configured to cause display of each of the plurality of sets of instant pricing structure data objects on a user device.

14. The system of claim 9, wherein the threshold for each respective parameter is determined based on historical data associated with the dealer and a predetermined limit associated with the respective parameter.

15. The system of claim 9, wherein the action is completing a purchase of the vehicle using the final pricing structure data object.

16. A non-transitory computer-readable medium having instructions stored thereon, execution of which, by one or more processors of a device, cause the one or more processors to perform operations comprising:
generating a plurality of instant pricing structure data objects for each vehicle in an inventory of a dealer, each instant pricing structure data object being unique;
receiving a request to identify a single instant pricing structure data object for each attribute of a set of attributes from the set of instant pricing structure data objects for a specified vehicle from the inventory of the dealer, and based on an input;
for each attribute of the set of attributes:
identifying a parameter from a set of parameters corresponding to a given attribute of the set of attributes; and
identifying a threshold for the parameter;
identifying a set of instant pricing structure data objects for the specified vehicle from the plurality of instant pricing structure data objects for which a value the parameter has been varied within the threshold, wherein each instant pricing structure data object of the set is constrained based on the input and a lender policy;
identifying a single instant pricing structure data object for each attribute of the set of attributes, from each set of instant pricing data objects; and
causing display of the single instant pricing structure data object for each attribute of the set of attributes.

17. The non-transitory computer-readable medium of claim 16, the operations further comprising ranking instant pricing structure data objects of each set of instant pricing structures data objects based on a score indicating a likelihood of being selected.

18. The non-transitory computer-readable medium of claim 17, wherein the score indicating a likelihood of being selected is based on previously selected instant pricing structure data objects.

19. The non-transitory computer-readable medium of claim 16, wherein the set of attributes are associated with previously selected final pricing structure data objects.

20. The non-transitory computer-readable medium of claim 16, wherein the threshold for the parameter is determined based on historical data associated with the dealer and a predetermined limit associated with the parameter.
